(19) United States
(12) Patent Application Publication
(10) Pub. No.: US 2017/0113341 A1
(43) Pub. Date: Apr. 27, 2017

(54) Air tool storage rail

(71) Applicant: Mark Mays, Newnan, GA (US)

(72) Inventor: Mark Mays, Newnan, GA (US)

(21) Appl. No.: 15/377,935

(22) Filed: Dec. 13, 2016

Related U.S. Application Data
(63) Continuation-in-part of application No. 14/993,940, filed on Jan. 12, 2016, now abandoned.
(60) Provisional application No. 62/109,428, filed on Jan. 29, 2015.

(51) Int. Cl. B25H 3/04

(52) U.S. Cl. CPC B25H 3/04

(57) ABSTRACT

An air tool storage rail provides a plurality of equally spaced slots on its bottom or side surface, enabling the user to hang an air tool from each slot by sliding the nipple of the air tool into the slot. The rail may be affixed magnetically to the side of a tool box, the interior of a vehicle or trailer, or some other vertical surface. Alternately, the rail may be affixed to a vertical surface with screws, bolts, or similar fasteners.

### CROSS-REFERENCE TO RELATED APPLICATIONS

This Application is a continuation in part which claims the benefit of U.S. patent application Ser. No. 14/993,940 filed Jan. 12, 2016 which claimed the benefit of U.S. Provisional Application No. 62/109,428, filed Jan. 29, 2015, which are hereby incorporated by reference.

### BACKGROUND OF THE INVENTION

The invention relates generally to air-powered tools and accessories and in particular to an air tool storage rail. For construction and renovation workers and contractors, tools powered by an air compressor have proven to be very cost-effective. Many job sites lack electric power, which may make standard power tools difficult to use. Unfortunately, air tools tend to be very large, bulky, and heavy. Storing them in a pickup truck or tool trailer can take up a large amount of space and does not secure the tools, leaving them vulnerable to theft as well as sliding around during travel, causing wear and tear.

A search of the prior art reveals various tool storage systems which have been developed to secure the tools. None are closely related to the present invention, but several include features which resemble those of the present invention. Each has proven to be less than satisfactory in its own way. The present invention has been developed for the purpose of addressing and resolving these disadvantages. An air tool storage rail, providing slots into which the nipples of air tools will slide easily to enable the user to hang the tools upside down, would resolve these problems.

Air tool rack, U.S. Pat. No. 5,386,915 (filed Nov. 3, 1993), provides a tool rack for storing air powered tools. The rack immobilizes each air powered tool by using a male air hose connector attached to the air powered tool. The male air hose connector has a flanged end and a neck region. The neck region has a diameter less than that of the flange region. The tool rack includes a first surface having a plurality of capture regions therein. Each tool capture region includes first and second regions. The first region has an opening sufficient to allow the passage of the flange region therethrough. The second region includes a slot having an opening less than the diameter of the flanged region but greater than the diameter of the neck region. The tool rack is attached to a surface such as the side of a tool box or tool tray-cart or to a wall via appropriate connectors. In the preferred embodiment, the tool rack also includes a surface having clips attached thereto for immobilizing one or more sockets for use in conjunction with the air powered tools.

Organizer for tools, U.S. Pat. No. 6,968,961 (filed Feb. 7, 2003), provides an organizer having a main body portion and a lip portion. The main body portion includes one or more wells, each well having a longitudinal length and a depth, well walls, and a front portion having an opening for receiving at least a portion of a tool. The lip portion is positioned adjacent the main body portion and includes one or more receiving members.

Tool storage organizer, U.S. Pat. No. 8,701,952 (filed Aug. 22, 2012), provides a tool storage organizer system which comprises a storage organizer installed on the back wall of a truck cabin. The organizer has a back support per with multiple layers of pocket disposed in the front and multiple horizontal pockets disposed in the back. The multiple layer pockets in the front have various heights but the same bottom ending levels. A plurality of bits slots are attached to pockets of the out layer pockets. The back support panel has multiple grommets near the edge, which are used to attach to brackets installed on the truck wall through a plurality of hooks. A hard rod is attached to the top edge of the back support panel to keep the support in shape when the back support panel is hung up.

Air compressor with demountable storing vessel, Chinese Patent No. 201027621 (filed Apr. 11, 2007), provides a compressor with detachable container, comprising a frame, and an compressor body in linkage connection with the driving motor through a drive mechanism. The compressor is provided with a container. Through arranging the detachable container on the frame of the prior compressor, the utility model is convenient for a staff member to take or store needed tool bag; meanwhile, the utility model reduces labor intensity of staff members and increases work efficiency; moreover, spare parts and air tools are easy to use and unlikely to be lost.

Tool die storage rack for machining workshop, Chinese Patent No. 204123387 (filed July 15, 2014), provides a storage rack comprising a frame, wherein the top face, the bottom face, the back face and one side face of the frame are sealed, a sliding door is arranged on the front face of the frame, and a folding door is arranged on the other side face of the frame; an observation window is arranged on the upper half of the folding door, and a permanent magnet for attraction closing is arranged on the edge of the folding door; an inner cavity of the frame is provided with a plurality of sliding supporting devices from top to bottom, each sliding supporting device comprises a partition plate with the two ends both fixedly connected to the frame, and a plurality of shaft rollers are arranged on the upper surfaces of the partition plates side by side; L-shaped exhaust channels communicated with the inner cavity of the frame are formed in the top face of the frame, axial flow fans are arranged on the horizontal segments of the exhaust channels, and electric tool die rack for the machining workshop further comprises a controller, and the axial flow fans and the electric tool die rack for the machining workshop is reasonable in structural design and good in ventilation effect.

Pneumatic-tool containing rack, Chinese Patent No. 203510184 (filed Sep. 26, 2013), provides a pneumatic-tool containing rack which comprises a rack body. The rack body is provided with a through hole, a storage groove, stop blocks and supporting legs. A rubber gasket is installed on the through hole. The storage groove is located in the left end of the rack body and is rectangular. Each stop block is provided with a cushion block, and the upper end of each cushion block is of an arc shape. The supporting legs are provided with reinforcing ribs. According to the pneumatic-tool containing rack, different spaces are arranged and used for containing pneumatic tools and parts, so that damage to the pneumatic tools and the parts is effectively avoided; moreover, the pneumatic-tool containing rack is easy to operate, economical and practical.

### SUMMARY OF THE INVENTION

Accordingly, the invention is directed to an air tool storage rail. The rail provides a plurality of equally spaced slots on its bottom or side surface, enabling the user to hang an air tool from each slot by sliding the nipple of the air tool into the slot. The rail may be affixed magnetically to the side of a tool box, the interior of a vehicle or trailer, or some other vertical surface. Alternately, the rail may be affixed to a vertical surface with screws, bolts, or similar fasteners.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment, displaying the rail 10, and the slots 11.

FIG. 2 is a front view of the second exemplary embodiment, displaying the rail 10, the slots 11, and the screw holes 12.

FIG. 3 is a top view of the first exemplary embodiment, displaying the rail 10, the slots 11, and the magnetic fastener 14.

FIG. 4 is a perspective view of the second exemplary embodiment, displaying the rail 10, the slots 11, the screw holes 12, and a air tool 13 stored on the rail 10.

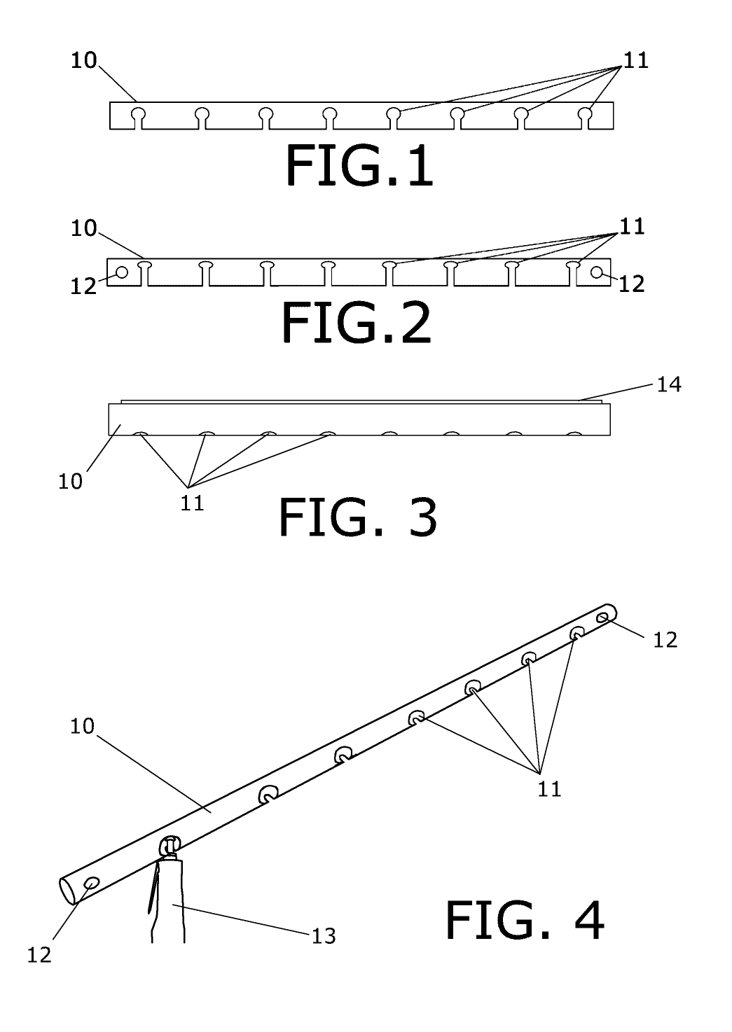

### DETAILED DESCRIPTION OF THE INVENTION

Referring now to the invention in more detail, the invention is directed to an air tool storage rail 10.

The first exemplary embodiment is comprised of a rail 10 which provides a plurality of equally spaced slots 11 on its bottom or side surface, enabling the user to hang an air tool from each slot 11 by sliding the nipple of the air tool 13 into the slot 11. The rail 10 is cylindrical in shape and hollow, such that when the nipple of the air tool 13 is inserted into the slot 11, the nipple is protected from damage. The rail 10 may be affixed magnetically via a magnetic strip 14 to the side of a tool box, the interior of a vehicle or trailer, or some other vertical surface.

The second exemplary embodiment is substantially similar in structure and function to the first exemplary embodiment, with the following modifications. The rail 10 may be affixed to a vertical surface with screws, bolts, or similar fasteners. For this purpose, a screw hole 12 is provided near each end of the rail 10.

To use the first or the second exemplary embodiment, the user affixes the rail 10 to the side of a tool box, the interior of a vehicle or trailer, or some other vertical surface. The user may then hang an air tool 13 from each slot 11 by sliding the nipple of the air tool into the slot 11.

The rail 10 is preferably cylindrical in shape, hollow, and manufactured from a rigid, durable material with substantial structural strength which is corrosion resistant, such as stainless steel or aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An air tool storage rail comprised of a cylindrical hollow rail which provides a plurality of equally spaced slots on its bottom or side surface, such that an air tool may be hung from the slots.

2. The air tool storage rail of claim 1, wherein the air tool has a nipple and said slots are sized and configured to the same shape as the nipple.

3. The air tool storage rail of claim 1, further comprising a magnetic strip such that the rail is affixed magnetically to a metallic surface.

4. The air tool storage rail of claim 2, further comprising a magnetic strip such that the rail is affixed magnetically to a metallic surface.

5. The air tool storage rail of claim 1, wherein the rail is manufactured from a rigid, durable material with substantial structural strength which is corrosion resistant, such as stainless steel or aluminum alloy.

6. The air tool storage rail of claim 2, wherein the rail is manufactured from a rigid, durable material with substantial structural strength which is corrosion resistant, such as stainless steel or aluminum alloy.

7. The air tool storage rail of claim 3, wherein the rail is manufactured from a rigid, durable material with substantial structural strength which is corrosion resistant, such as stainless steel or aluminum alloy.

8. The air tool storage rail of claim 4, wherein the rail is manufactured from a rigid, durable material with substantial structural strength which is corrosion resistant, such as stainless steel or aluminum alloy.

9. The air tool storage rail of claim 1, further comprising screw holes; said screw holes being sized and shaped such that the cylindrical hollow rail to a vertical surface with screws, bolts, or similar fasteners.

10. The air tool storage rail of claim 2, further comprising screw holes; said screw holes being sized and shaped such that the cylindrical hollow rail to a vertical surface with screws, bolts, or similar fasteners.

11. The air tool storage rail of claim 9, wherein the rail is manufactured from a rigid, durable material with substantial structural strength which is corrosion resistant, such as stainless steel or aluminum alloy.

12. The air tool storage rail of claim 10, wherein the rail is manufactured from a rigid, durable material with substantial structural strength which is corrosion resistant, such as stainless steel or aluminum alloy.

13. The air tool storage rail of claim 9, wherein said screw holes are positioned near each end of the rail.

14. The air tool storage rail of claim 10, wherein said screw holes are positioned near each end of the rail.

15. The air tool storage rail of claim 11, wherein said screw holes are positioned near each end of the rail.

16. The air tool storage rail of claim 12, wherein said screw holes are positioned near each end of the rail.
